(19) United States
(12) Patent Application Publication
(10) Pub. No.: US 2020/0131899 A1
(43) Pub. Date: Apr. 30, 2020

(54) Systems and Methods for Measuring Inflow in a Well

(71) Applicant: WellDiver LLC, Stafford, TX (US)

(72) Inventors: Ting Chen, Missouri City, TX (US); Ramachandra Shenoy, Katy, TX (US); Indranil Roy, Missouri City, TX (US)

(73) Assignee: WellDiver LLC, Stafford, TX (US)

(21) Appl. No.: 16/155,765

(22) Filed: Oct. 9, 2018

Related U.S. Application Data
(60) Provisional application No. 62/569,659, filed on Oct. 9, 2017.
(60) Provisional application No. 62/583,668, filed on Nov. 9, 2017.
(60) Provisional application No. 62/586,232, filed on Nov. 15, 2017.

(51) Int. Cl. E21B 47/10; G01V 9/02; E21B 43/26; E21B 47/06; E21B 47/09

(52) U.S. Cl. CPC E21B 47/10; G01V 9/02; E21B 47/091; E21B 47/06; E21B 47/065; E21B 43/26

(57) ABSTRACT

Systems and methods for deploying a sensor ball into a well are disclosed. The ball is buoyant and can carry sensors within. A dissolvable or otherwise removable weight can be attached to the ball such that the ball can sink to a desired depth and when the weight is removed the ball can passively float back to the surface. As the ball floats past inflow stages an accelerometer in the ball records data, allowing better decisions to be made about which stages are producing and which are not.

### CROSS-REFERENCE TO RELATED APPLICATIONS

This application claims priority to U.S. Provisional Patent Application No. 62/569,659 entitled “Well Diver” filed on Oct. 9, 2017, U.S. Provisional Patent Application No. 62/583,668 entitled “Intelligent Water Reactive Device for Zonal Isolation With Diminished Water Hammer and Reusable Sensor” filed Nov. 9, 2017, and U.S. Provisional Patent Application No. 62/586,232 entitled “Sensor Pressure Housing in Intelligent Water-Reactive Device for Zonal Isolation with Diminished Water Hammer with Continual Data Recording and Method of Retrieval filed on Nov. 15, 2017, all of which are incorporated herein by reference in their entirety.

### BACKGROUND

Examples of self-contained, battery powered miniature wellbore pressure and temperature sensors and associated recorders are known as shown in U.S. Pat. No. 8,931,347 to Donzier et al. Typically, however, these devices are fixed or tethered by electric cable, slick line, or pipe and if they are free-flowing, their buoyancy is fixed as in “Smartball Flowable Pressure and Temperature Micro-Recorder, shown at www.openfield-technology.com. Therefore, their trajectory within the well bore is uncontrolled and uncertain. They may or may not reach the desired depth or location within the well. Compared to the present disclosure, prior art systems are neither deployable to a desired depth nor readily retrievable after performing their measurements. Prior art also lacks the capability to make a complete set of measurements clients require for wellbore reconnaissance.

For water cut measurement, examples exist using capacitance measurement such as shown in U.S. Pat. No. 9,116,105. However, these devices are not self-contained, i.e., their capacitance measurement is relative to an external electrode, such as the ID of a fixed pipe (e.g., casing, production tubing, or intelligent completion flow control valve tube).

Examples of free-flowing tags, flowable devices, and encapsulated micro-sensors have been patented but their sensors and retrievability features have not been developed. It appears they do not have a complete system for deployment positioning downhole, power, control, sensing, recording and retrieval as described by the present disclosure.

Other prior art efforts have made claim to a retrievability feature using a change in specific gravity (i.e., dropping a weight or dissolving something), but this is a well-known technique and appears to be an obvious application of known state-of-the-art in dissolvable materials used commercially in fracking plugs. This prior art gives no details or examples to determine feasibility and cannot execute on command.

### SUMMARY

Embodiments of the present disclosure are directed to a method including providing a ball into a wellbore, the ball having a dissolvable weight and a shell forming an interior region and a gauge port, a pressure gauge, a temperature gauge, and an accelerometer in the interior region. The pressure gauge and temperature gauge take readings of pressure and temperature through the pressure port. The accelerometer is configured to measure inflow into the wellbore local to the ball. The method also includes allowing the ball to reach a desired depth and dissolving the ball at the desired depth. The ball without the dissolvable weight is buoyant. The method also includes monitoring a position of the ball relative to a plurality of inflow stages as the ball floats from the desired depth toward the surface. The accelerometer is configured to measure an inflow at one or more of the inflow stages and to record data accordingly.

In further embodiments of the present disclosure the method includes monitoring the position of the ball relative to a plurality of inflow stages comprises measuring the position of the ball relative to one or more collar coil locators in the wellbore.

Other embodiments of the present disclosure are directed to a system for monitoring inflow in a well having a plurality of inflow stages. The system includes a ball having an interior portion, an accelerometer positioned within the interior portion and being configured to monitor inflow from one or more of the stages, and a data recording component in the interior portion configured to record data from the accelerometer. The ball including the accelerometer and data recording component is buoyant in the well. The system also includes a dissolvable weight configured to selectively dissolve at a desired location in the well. The ball and weight together are not buoyant. When the ball reaches a desired depth in the well the dissolvable weight is dissolved, rendering the ball buoyant such that the ball floats back to the surface for retrieval.

Still further embodiments of the present disclosure are directed to a method for determining which stages of a multi-stage well are producing. The method includes deploying a ball into a well, the ball having an accelerometer configured to measure an increase in inflow as the ball moves past various stages in the well. The ball has a selectively removable weight. Without the weight the ball is buoyant and with the weight the ball sinks. The method also includes dropping the ball and weight into the well, removing the weight from the ball to render the ball buoyant, and allowing the ball to float back to the surface for retrieval. The method also includes monitoring a position of the ball relative to a plurality of stages in the well, and recording data pertaining to inflow at the various stages.

### BRIEF DESCRIPTION OF THE FIGURES

FIG. 2 shows a ball floating through a well according to embodiments of the present disclosure.

FIGS. 3A and 3B show a graph of cumulative production starting from a toe of the well and moving upward toward the highest stage in the well.

FIG. 4 shows several views of a ball according to embodiments of the present disclosure, including cross sectional and isometric views.

FIG. 5 shows other embodiments in which the ball is made having interior ribs to provide additional strength to the ball.

FIGS. 6A, 6B, and 6C are isometric, exploded, and cross-sectional views respectively of a ball according to embodiments of the present disclosure.

FIG. 7 shows a schematic cross-sectional view of deployment and retrieval of a ball according to embodiments of the present disclosure.

### DETAILED DESCRIPTION

Below is a detailed description according to various embodiments of the present disclosure. The present disclosure is directed to a design and methodology to develop water reactive alloys both unique in chemistry and processing for strength. Features of the present disclosure are capable of use in many applications, such as well monitoring, flow assurance, temperature gradient logging, multi-state fracture monitoring, production logging, reservoir evaluation, water injection monitoring, pipeline integrity evaluation, pipeline integrity evaluation, and pipeline leak detector.

FIG. 1 is a schematic illustration of a ball 100 according to embodiments of the present disclosure. The ball 100 can be a hollow, water-reactive ball comprising an outer housing for digital hydraulic fracturing or multi-state stimulation sensor packages. The ball 100 can be made from high strength, high ductility water-reactive or degradable alloys and it deployable in a wellbore. The ball can include a buoyant pressure chamber 102 that can include a noise maker 104 so that when near the surface the ball 100 is locatable. The ball 100 also includes a pressure and/or temperature sensor 106. Some embodiments the sensor 106 can sense pressure, temperature, or both pressure and temperature. The ball 100 can also include a dissolved O₂ sensor 108. The ball 100 can also include a casing collar locator (CCL) sensor 110. The ball 100 is shown here in a wellbore adjacent to casing collar coils 112 that are placed within the wellbore. The CCL sensor 110 and coils 112 enable the location of the ball 100 in the well to be recorded. The ball 100 can also include a water cut sensor 114. The ball 100 can also be equipped with a data recorder 116 and a battery 118 to provide power to other components as needed in the ball 100. In some embodiments dielectric electrodes can be placed in the casing to enable water cut measurement to be made.

The ball 100 can also include an accelerometer 120 configured to measure acceleration of the ball 100 within the wellbore. The accelerometer 120 enables measurement of inflow at various locations within the wellbore. The ball 100 can also include a dissolvable sinker weight 124 which can be made of various dissolvable materials configured to selectively dissolve at various conditions in the well. The dissolvable material can be tailored to dissolve at different depths, chemical concentrations, etc. The ball 100 can be deployed into a wellbore and allowed to sink to a desired depth at which point the weight 124 is dissolved and the ball 100 becomes buoyant and begins to float up to the surface, gathering data along the way. Once the ball 100 reaches the surface it can easily be retrieved and the data recorded can be accessed. There is no need to pump up the ball 100 or to flow the well upward to retrieve the ball. It comes due to its own natural buoyancy.

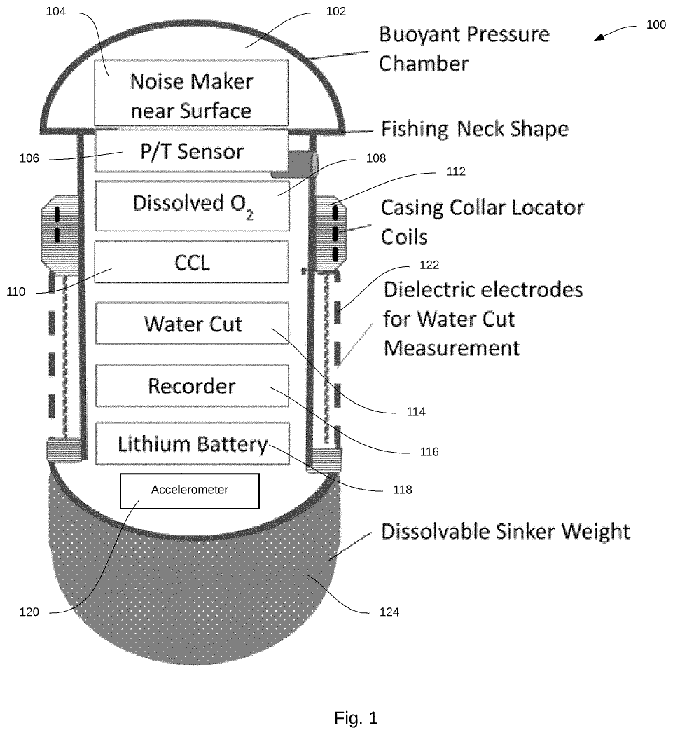

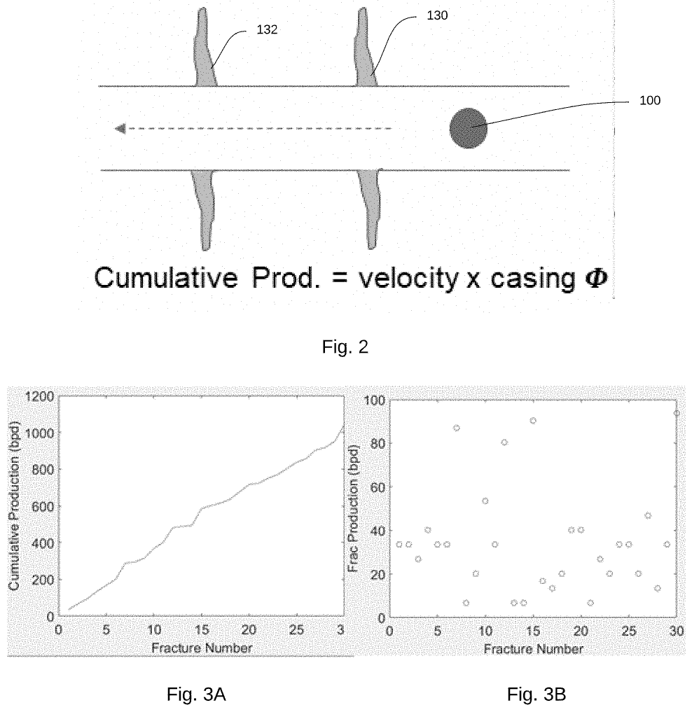

FIG. 2 shows a ball 100 floating through a well according to embodiments of the present disclosure. The ball 100 can be moving to the left in a deviated well under its own buoyancy according to embodiments of the present disclosure. The ball 100 floats past two stages 130 and 132. The sensors in the ball 100 are configured to record data as it passes these stages, including acceleration data which can be used to determine the amount of inflow at each stage. FIGS. 3A and 3B show a graph of cumulative production starting from a toe of the well and moving upward toward the highest stage in the well. Each time the ball 100 passes a stage the inflow numbers are increased for the stages that are producing. For stages that are not producing, the cumulative number will increase little or not at all. Using this information in connection with the location of the ball, the stages that are not producing can be identified. FIG. 3B shows cumulative production as a function of fracture number. In this example, stages 8, 13, 14, and 21 appear to be producing very little or not at all. This information is very valuable because it allows the operator to forego efforts to complete and produce from these stages, saving millions of dollars of time and effort for what is sure to be very little to zero yield from these stages.

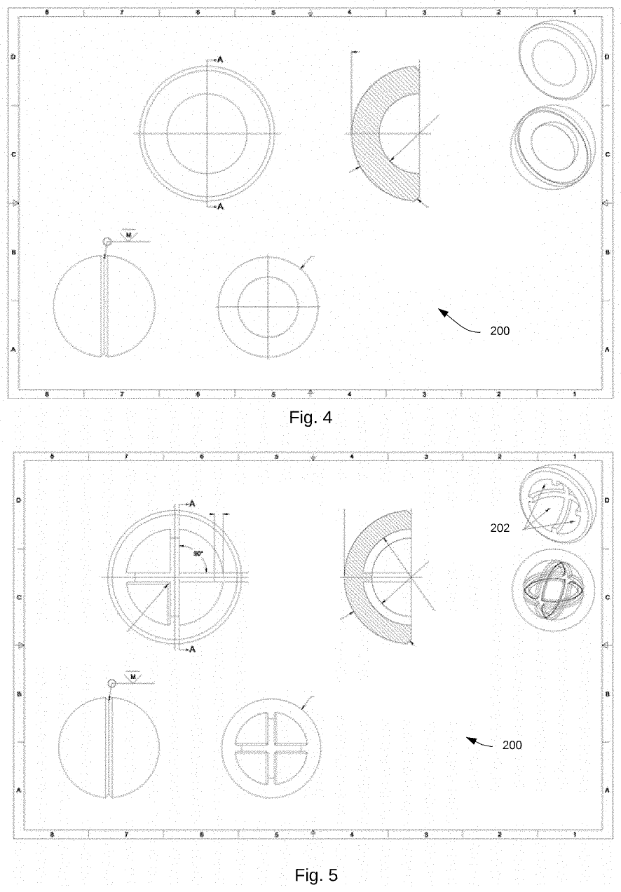

FIG. 4 shows several views of a ball 200 according to embodiments of the present disclosure, including cross sectional and isometric views. The ball 200 can be spherical and have an interior cavity which houses interior components. The ball 200 can have a threaded connection between hemispheres of the ball 200 which can be screwed together to seal the ball. FIG. 5 shows other embodiments in which the ball 200 is made having interior ribs 202 to provide additional strength to the ball 200. The ribs 202 can be on the interior surface of the ball 200 and can be orthogonal extending around an interior circumference of the ball 200.

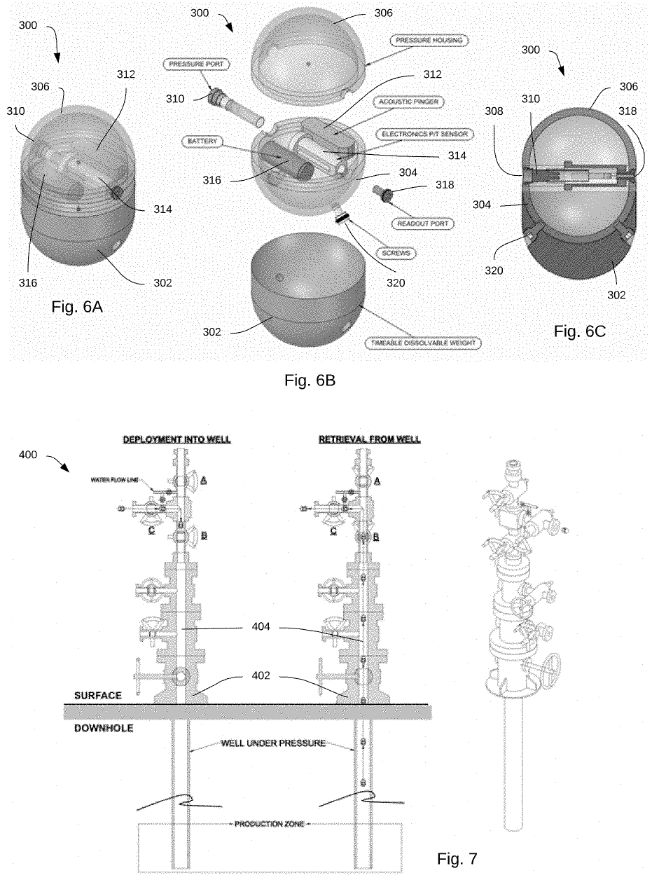

FIGS. 6A, 6B, and 6C are isometric, exploded, and cross-sectional views respectively of a ball 300 according to embodiments of the present disclosure. The ball 300 can include a dissolvable weight 302, a pressure housing lower portion 304 and upper portion 306 that together form a sealed structure for the ball 300. The upper and lower portions can be hemispherical forming a hollow enclosure between them and can be threadably connected together. The pressure housing can withstand up to 10,000 psi of pressure. The housings have a port 308 formed intersecting the circumferential threaded connection. A pressure gauge 310 can be situated in the port 308 with a pressure-sensing portion exposed through the port 308. Other components within the ball 300 can include an acoustic pinger 312, an electronics module 314 and a battery 316. The ball 300 can also include a readout port 318 and screws 320 on the exterior of the ball 300. The screws are configured to hold the dissolvable weight 302 to the lower portion 304 of the ball 300. The ball 300 including weight 302 can be dense enough to sink at atmospheric pressure and throughout a wellbore, while without the weight 302 the ball 300 is buoyant enough to float. The ball 300 can be deployed into a wellbore and allowed to sink to the bottom or to any other desirable location at which point the weight is dissolved and the ball 300 floats to the top, taking data along the way.

FIG. 7 shows a schematic cross-sectional view of deployment and retrieval of a ball according to embodiments of the present disclosure. A well 400 can be at surface or on a sea bed. The wellhead 402 can include a valve A, a valve B, valve C, a riser pipe 404 and an entry port 406. In some embodiments the deployment of the ball is as follows: Wellhead 402 is opened, valve B is opened, and valve A is opened. The ball is placed into the riser pipe 404 directly or into a side port. Valve A is closed, and valve B is opened. The wellhead valve is opened and the ball descends and records data as programmed. For retrieval after the ball has descended, logged, and dissolved a weight, the following can be executed to retrieve the ball: Valve A is closed, wellhead valve is opened, and valve B is opened. The ball will float back to the surface and into the rise pipe 404. The acoustic pinger (shown in FIGS. 6A-6C) can verify that the ball has arrived.

In some embodiments the ball can be filled with a fluid such as water or oil or another suitable fluid to help to improve the ball's ability to withstand pressure as it is moved into the well. In some embodiments the ball is filled with a low density, incompressible material such as oil, Teflon™, aluminum, or composites such as an aluminum polymer composite (APC) metal foam filled with a high temperature polymer such as PFA (perfluoroalkoxy), FEP (polyfluoroethylenepropylene) or PFE (polytetrafluoroethylene). Other similar fluids are also possible.

The ball may be allowed to descend into the well until it reaches a seat, and the ball and seat can form a seal sufficiently strong to perform a perforating or a multi-state stimulation operation above the ball and seat seal. In some embodiments the density of the ball is tailored such that the ball is heavy enough to sink, but only just so such that the descent is slow and measured. This helps to mitigate strong forces that can occur with conventional balls that must be pumped down into the well. The structure of the ball is strong enough to withstand the impact force and the pressure applied. In some cases the pressure is as much as 20,000 psi. In some embodiments the ball can have two pressure sensors, each on different sides of the ball to improve the chances that a pressure reading can be taken from each side, with one side above the seal and another below. In some embodiments there may be three ports to ensure that at least one of the ports is above the seal. In this way, there is sure to be a measurement above the seal.

The foregoing disclosure hereby enables a person of ordinary skill in the art to make and use the disclosed systems without undue experimentation. Certain examples are given to for purposes of explanation and are not given in a limiting manner.

1. A method, comprising:
providing a ball into a wellbore, the ball having a dissolvable weight and a shell forming an interior region and a gauge port, a pressure gauge, a temperature gauge, and an accelerometer in the interior region, the pressure gauge and temperature gauge being configured to take readings of pressure and temperature through the pressure port, wherein the accelerometer is configured to measure inflow into the wellbore local to the ball;
allowing the ball to reach a desired depth;
dissolving the ball at the desired depth, wherein the ball without the dissolvable weight is buoyant;
monitoring a position of the ball relative to a plurality of inflow stages as the ball floats from the desired depth toward the surface, wherein the accelerometer is configured to measure an inflow at one or more of the inflow stages and to record data accordingly.

2. The method of claim 1 wherein the desired depth comprises a seat in the well, wherein the ball is sufficiently strong to withstand approximately 10,000 psi while seated on the seat.

3. The method of claim 1, further comprising retrieving the ball and recording the data.

4. The method of claim 1, further comprising performing a fracturing operation on the stages that have significant inflow.

5. The method of claim 1 wherein the ball further includes an acoustic pinger to confirm location at the surface.

6. The method of claim 1 wherein the interior region of the ball is filled with at least one of oil, Teflon™, aluminum, an aluminum polymer composite metal foam filled with at least one of perfluoroalkoxy, polyfluoroethylenepropylene, or polytetrafluoroethylene.

7. The method of claim 1, further comprising monitoring the position of the ball relative to a plurality of inflow stages comprises measuring the position of the ball relative to one or more collar coil locators in the wellbore.

8. The method of claim 1 wherein the desired depth comprises a toe of the well.

9. The method of claim 1 wherein the dissolvable weight is configured to dissolve in at least one of water or brine.

10. The method of claim 1 wherein allowing the ball to reach the desired depth is accomplished without the use of a pump.

11. The method of claim 1 wherein the ball is configured to float to the surface without using a pump.

12. A system for monitoring inflow in a well having a plurality of inflow stages, the system comprising:
a ball having an interior portion;
an accelerometer positioned within the interior portion and being configured to monitor inflow from one or more of the stages;
a data recording component in the interior portion configured to record data from the accelerometer, wherein the ball including the accelerometer and data recording component is buoyant in the well;
a dissolvable weight configured to selectively dissolve at a desired location in the well, wherein the ball and weight together are not buoyant, wherein when the ball reaches a desired depth in the well the dissolvable weight is dissolved, rendering the ball buoyant such that the ball floats back to the surface for retrieval.

13. The system of claim 12, further comprising one or more locators in the well, wherein the locations of the locators is known relative to the inflow stages such that the inflow data recorded by the accelerometer is correlated to the inflow at the various stages.

14. The system of claim 13 wherein the locators comprise casing collar locators.

15. The system of claim 13 wherein the dissolvable weight has a concave portion configured to couple to an exterior surface of the ball.

16. The system of claim 12, further comprising a temperatures sensor in the interior portion of the ball.

17. The system of claim 12, further comprising a pressure sensor in the interior portion of the ball.

18. The system of claim 12, further comprising a dissolved oxygen sensor in the interior region.

19. A method for determining which stages of a multi-stage well are producing, the method comprising:
deploying a ball into a well, the ball having an accelerometer configured to measure an increase in inflow as the ball moves past various stages in the well, wherein the ball has a selectively removable weight, wherein without the weight the ball is buoyant and with the weight the ball sinks;
dropping the ball and weight into the well;
removing the weight from the ball to render the ball buoyant;
allowing the ball to float back to the surface for retrieval;
monitoring a position of the ball relative to a plurality of stages in the well; and
recording data pertaining to inflow at the various stages.

20. The method of claim 19 wherein the selectively removable weight comprises a dissolvable weight.

21. The method of claim 19 wherein monitoring the position of the ball relative to the plurality of stages comprises using casing collar locators in the well.

22. The method of claim 19, further comprising performing a fracturing operation at stages where inflow is greatest.
